(19) United States
(12) Patent Application Publication
(10) Pub. No.: US 2016/0281752 A1
(43) Pub. Date: Sep. 29, 2016

(54) RAIL COUPLING ASSEMBLY

(71) Applicant: Barrett Koller, Pueblo, CO (US)

(72) Inventor: Barrett Koller, Pueblo, CO (US)

(21) Appl. No.: 14/670,151

(22) Filed: Mar. 26, 2015

(51) Int. Cl. F16B 2/04; E04F 11/18; F16B 9/02

(52) U.S. Cl. CPC F16B 2/04; F16B 9/023; E04F 11/1812

(57) ABSTRACT

A rail coupling assembly is described. Embodiments of the rail coupling assembly can be implemented to couple a rail to the rail coupling assembly. The rail coupling assembly can then be coupled to a structure. The rail coupling assembly can generally include a flange, a flange bolt, an expansion member, an expansion member nut, and a semi-rigid member. The flange bolt can couple the flange, the semi-rigid member, and the expansion member together. Generally, the expansion member nut can be located within a bore of the expansion member. The flange bolt can threadably couple to the expansion member nut. In some embodiments, one or more rail coupling assemblies can be implemented to couple a plurality of rails together.

### BACKGROUND

Conventional means of securing a rail to a pool deck involves using a floor flange bolted to a concrete deck and the rail being coupled to the flange. As shown in FIG. 1, the flange 12 is coupled to a concrete deck by one or more bolts. To couple the rail 16 to the flange 12, the rail 16 is inserted into the flange 12 and secured by a bolt 14 being inserted through a pair of holes in the rail 16. Typically, the conventional means of coupling the flange and rail allows for small amounts of movement that lead to the rail becoming loose and unsafe overtime. As such, the conventional means of securing a rail to a flange becomes loose after time, requiring the rail to be recoupled or even replaced. Further, since most of the flanges extend a ways up to provide a more secure coupling, the flanges are not able to be covered up and can be unsightly.

Therefore, a more aesthetically pleasing and secure means of coupling a rail to a flange is needed.

### BRIEF DESCRIPTION OF THE DRAWINGS

FIG. 1 is a perspective view of a prior art means of securing a rail to concrete.

FIG. 2 is a perspective view of a rail coupling assembly according to one embodiment of the present invention.

FIG. 3A is a side sectional view of a rail coupling assembly according to one embodiment of the present invention.

FIG. 3B is a side sectional view of a rail coupling assembly according to one embodiment of the present invention

FIG. 3C is a side sectional view of a rail coupling assembly according to one embodiment of the present invention.

FIG. 4A is a side view of a flange according to one embodiment of the present invention.

FIG. 4B is a side sectional view of a flange according to one embodiment of the present invention

FIG. 4C is a perspective view of a flange according to one embodiment of the present invention.

FIG. 5A is an exploded perspective view of an expansion member according to one embodiment of the present invention.

FIG. 5B is a front interior view of an expansion member according to one embodiment of the present invention

FIG. 6A is a front view of a nut according to one embodiment of the present invention.

FIG. 6B is a side view of a nut according to one embodiment of the present invention

FIG. 6C is a perspective view of a nut according to one embodiment of the present invention.

FIG. 7 is a perspective view of a rail coupling assembly including an escutcheon plate according to one embodiment of the present invention.

FIG. 8 is a perspective view of a rail coupling system according to one embodiment of the present invention.

FIG. 9A is a perspective view of a rail coupling assembly according to one embodiment of the present invention.

FIG. 9B is a top view of an engagement member according to one embodiment of the present invention.

FIG. 9C is a perspective view of an engagement member according to one embodiment of the present invention.

FIG. 10A is a side sectional view of a rail coupling assembly according to one embodiment of the present invention.

FIG. 10B is a side sectional view of a rail coupling assembly according to one embodiment of the present invention

FIG. 10C is a side sectional view of a rail coupling assembly according to one embodiment of the present invention.

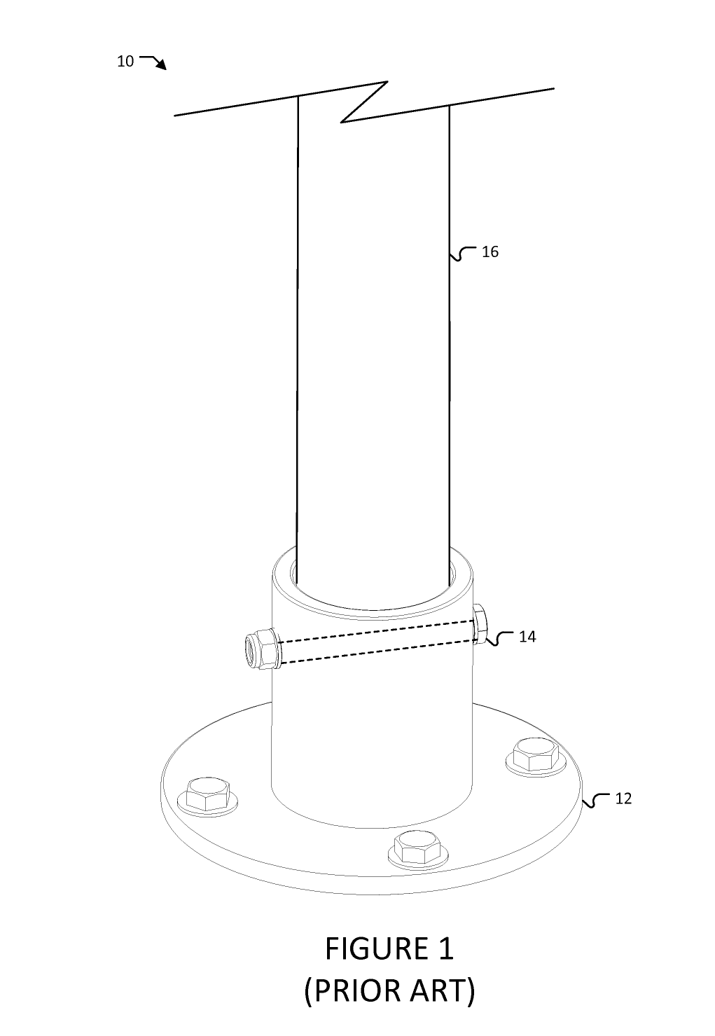

### DETAILED DESCRIPTION

Embodiments of the present invention include a rail coupling assembly adapted to secure a rail to the rail coupling assembly and a structure. In a typical implementation, the rail coupling assembly can create a connection having near weld-like strength between the rail and the rail coupling assembly. The rail and the rail coupling assembly can then be coupled to the structure. For instance, the rail coupling assembly can be implemented to couple a support rail to a pool deck.

In one embodiment, the rail coupling assembly can include a flange, a flange bolt, an expansion member, an expansion member nut, and a plurality of washers. The flange bolt can be implemented to indirectly couple the expansion member to the flange. The expansion member nut can reside within a bore of the expansion member and can include a threaded bore. The flange bolt can be adapted to threadably couple to the expansion member nut. Typically, the washers can be located between the flange and the expansion member. When assembled, the flange bolt can be passed through a hole of the flange, pass through the washers, then pass through the bore of the expansion member to threadably couple to the expansion member nut bore.

In a typical implementation, a protruding member of the flange, the washers, the expansion member, and the expansion member nut (inside the expansion member) can be inserted into a rail. Once the mentioned components are inside the rail, the flange bolt can be threaded through the expansion member nut. As the flange bolt is threaded, the expansion member nut can be moved down through the bore of the expansion member. As the expansion member nut moves, the expansion member can increase in diameter to interface with and couple to an inside of the rail. As the flange bolt is threaded further, the expansion member and the rail can move towards the flange. The flange bolt can be threaded further to create a connection having weld-like strength between the flange and the rail. The flange can then be coupled to a structure. In some embodiments, the rail coupling assembly can include an escutcheon plate to cover up one or more fasteners securing the rail coupling assembly to the structure.

Embodiments of the present invention can implement a mechanical coupling in place of a more permanent coupling without sacrificing the benefits of the more permanent coupling. For instance, instead of having to weld components together, the rail coupling assembly described herein can be implemented. Embodiments of the present invention can include benefits similar to welded components, but with the adjustability of conventionally implemented couplings for rails. By using a mechanical coupling in place of a more permanent coupling, the present invention can be disassembled and reused. Further, the mechanical coupling allows unskilled laborers to install the rail coupling assembly, keeping costs down.

Embodiments of the present invention can be implemented for a variety of different applications. For instance, the rail coupling assembly can be implemented to secure a pool support rail to a concrete pool deck, then disassembled, and used a different location for securing a support rail of a hand rail system to a set of steps.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### A First Embodiment of a Rail Coupling Assembly

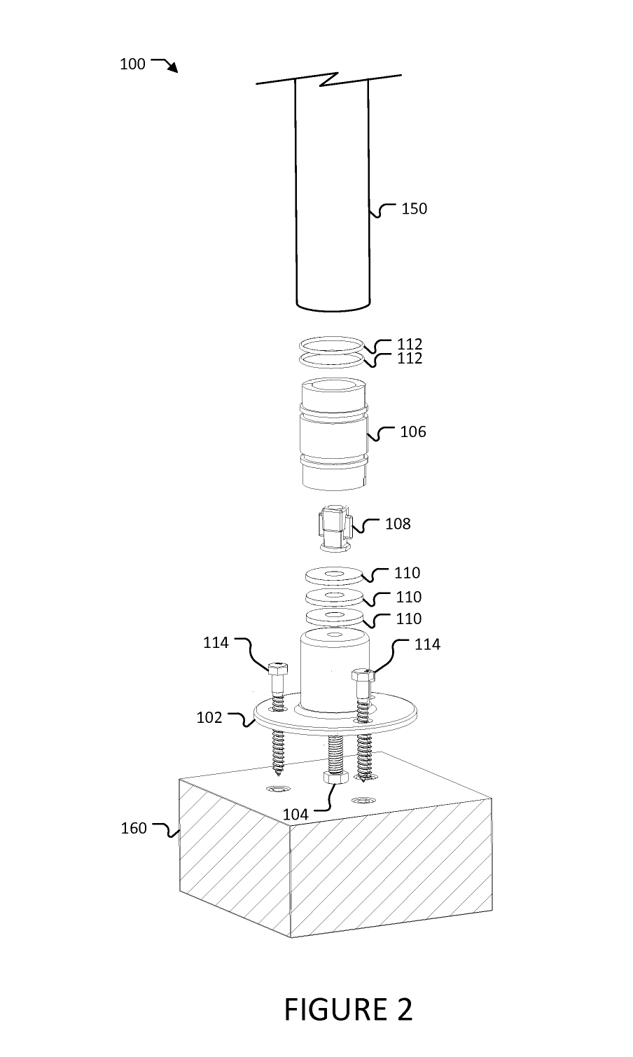

Referring to FIG. 2, an exploded view of an embodiment 100 showing a rail coupling assembly is illustrated. Generally, the rail coupling assembly 100 can be implemented to secure a rail to a structure. For instance, the rail coupling assembly 100 can be implemented to secure a support rail 150 to a pool deck 160. In one embodiment, the rail coupling assembly 100 can be implemented as a kit.

Typically, the rail coupling assembly 100 can include a flange 102, a flange bolt 104, an expansion member 106, an expansion member nut 108, a plurality of washers 110, a plurality of elastic rings 112, and one or more fasteners 114.

As shown in FIG. 2, the rail coupling assembly 100 can be implemented to secure the support rail 150 to the pool deck 160. Typically, the support rail 150 can be coupled to the rail coupling assembly 100 before being coupled to the pool deck 160. The rail coupling assembly 100 can be implemented to create a load bearing connection between the flange 102 and the support rail 150. By implementing the assembly 100, substantially weld-like strength can be created while still maintaining the ability to disassemble without destroying components of the assembly 100 and the support rail 150.

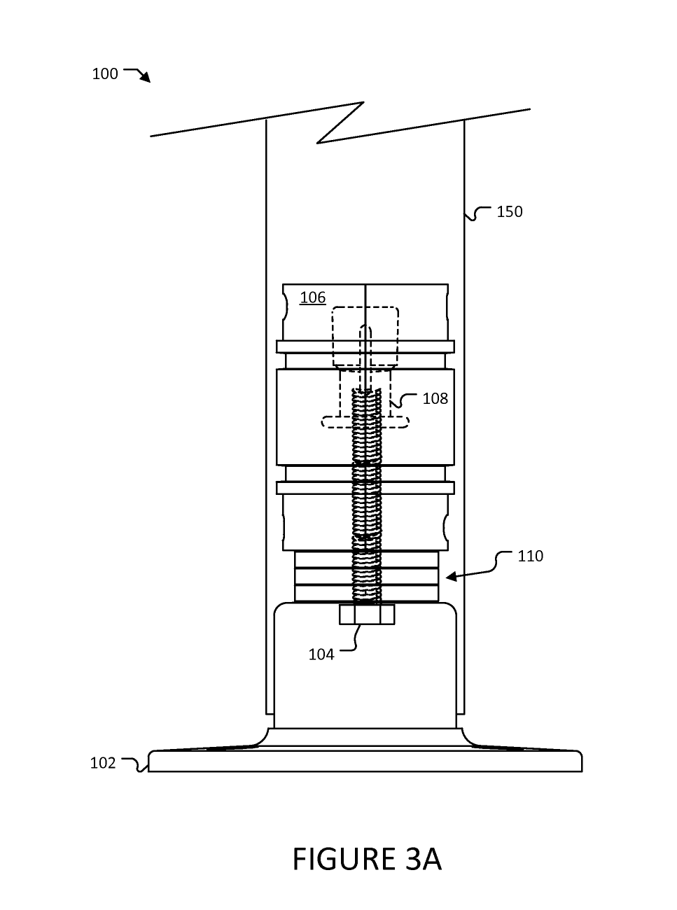

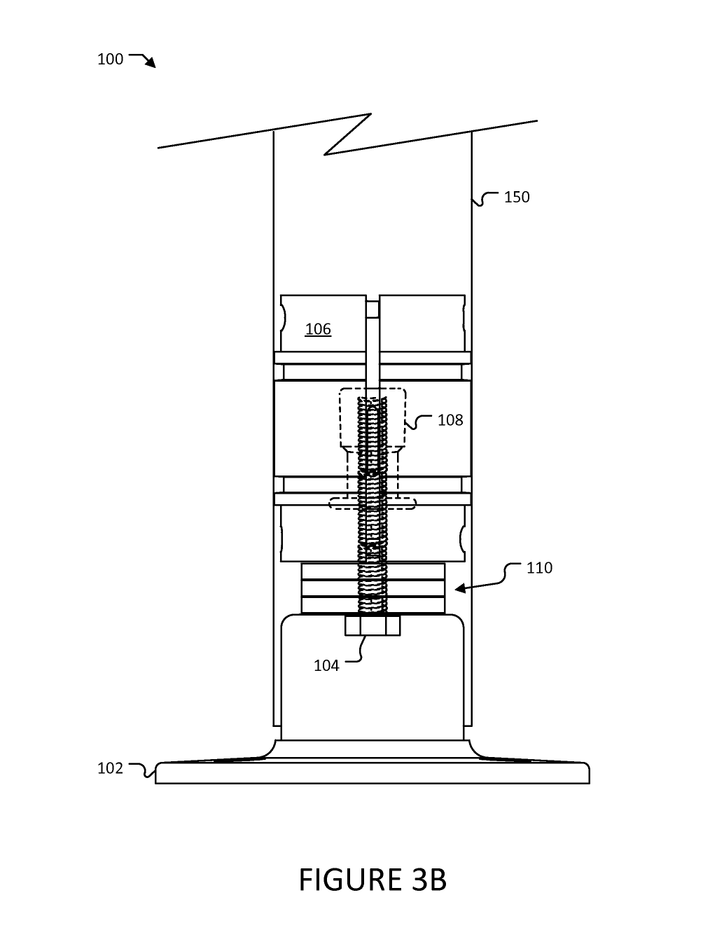

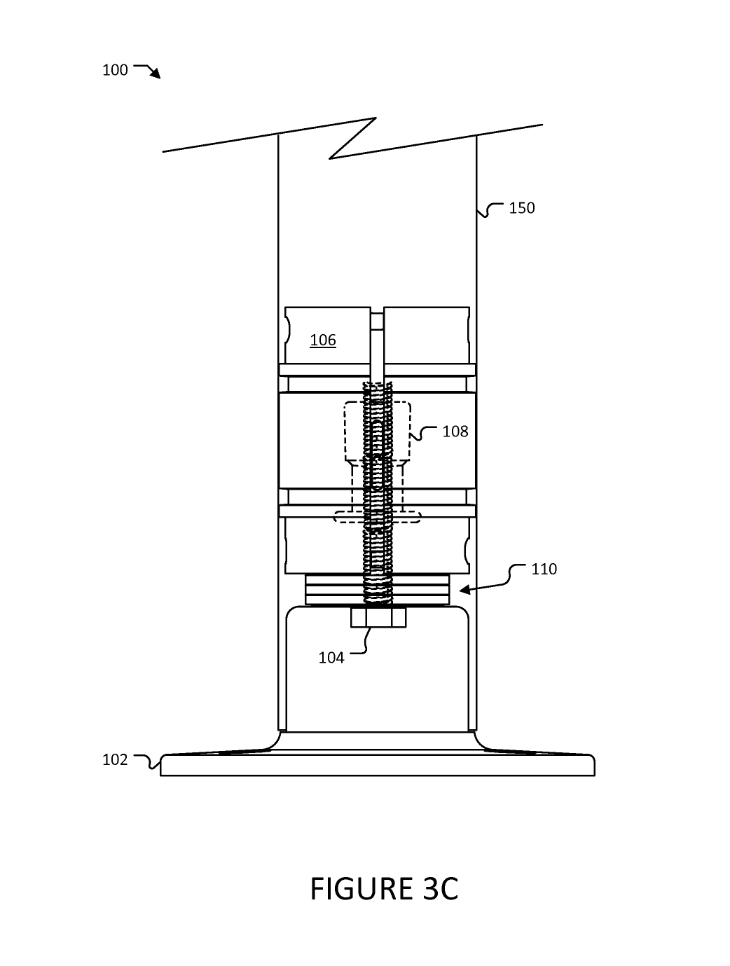

Referring to FIGS. 3A-3C, a typical implementation of the rail coupling assembly 100 being coupled to the support rail 150 is illustrated. In an initial step (not shown), the rail coupling assembly 100 can be partially inserted into the support rail 150. Typically, a portion of the flange 102, the flange bolt 104, the plurality of washers 110, the expansion member 106, and the expansion member nut 108 can be inserted into the support rail 150.

As shown in FIG. 3A, the expansion member 106 can generally fit inside the support rail 150 such that the expansion member 106 can be moved through the support rail 150. A gap is shown between the interior of the support rail 150 and the expansion member 106 for illustrative purpose only. Typically, the gap between the expansion member 106 and the support rail 150 is substantially smaller providing a snug fit. When first inserted, the expansion member nut 108 can be located approximate an upper portion of the expansion member 106. The flange bolt 104 can be threaded through the washers 110, the expansion member 106, and can be threadably coupled to the expansion member nut 108.

As shown in FIG. 3B, as the flange bolt 104 is threaded further through the expansion member nut 108, the expansion member nut 108 can be moved down through the expansion member 106. As the expansion member nut 108 moves down, the expansion member 106 can be expanded to interface with and couple to an interior of the support rail 150. Typically, a diameter of the expansion member 106 can be increased to interface with the interior of the support rail 150. As shown, the gap between the support rail 150 and the expansion member 106 is gone.

As shown in FIG. 3C, the flange 102 and a bottom portion of the support rail 150 can be connected together. As the flange bolt 104 is threaded even further through the expansion member nut 108, the expansion member 106 and the support rail 150 can be pulled closer to the flange 102. Typically, the expansion member nut 108 can be adapted to move to approximately a middle portion of the expansion member 106. Once the expansion member nut 108 is approximate the middle portion, the expansion member nut 108 can be adapted to stop moving through the expansion member 106.

As the expansion member 106 is pulled closer, the support rail 150 can be pulled down to interface with the flange 102. A load bearing connection between the support rail 150 and the flange 102 can be created by further threading the flange bolt 104 through the expansion member nut 108. Typically, the plurality of washers 110 can provide a restorative force to the expansion member 106 as the expansion member 106 is pulled closer to the flange 102. As shown in FIG. 3C, the washers 110 can be compressed as the expansion member 106 is pulled closer to the flange 102. The restorative force from the washers 110 can create a tighter fit between the flange 102 and the support rail 150. For instance, a connection having substantially weld-like strength can be created between the flange 102 and the bottom portion of the support rail 150.

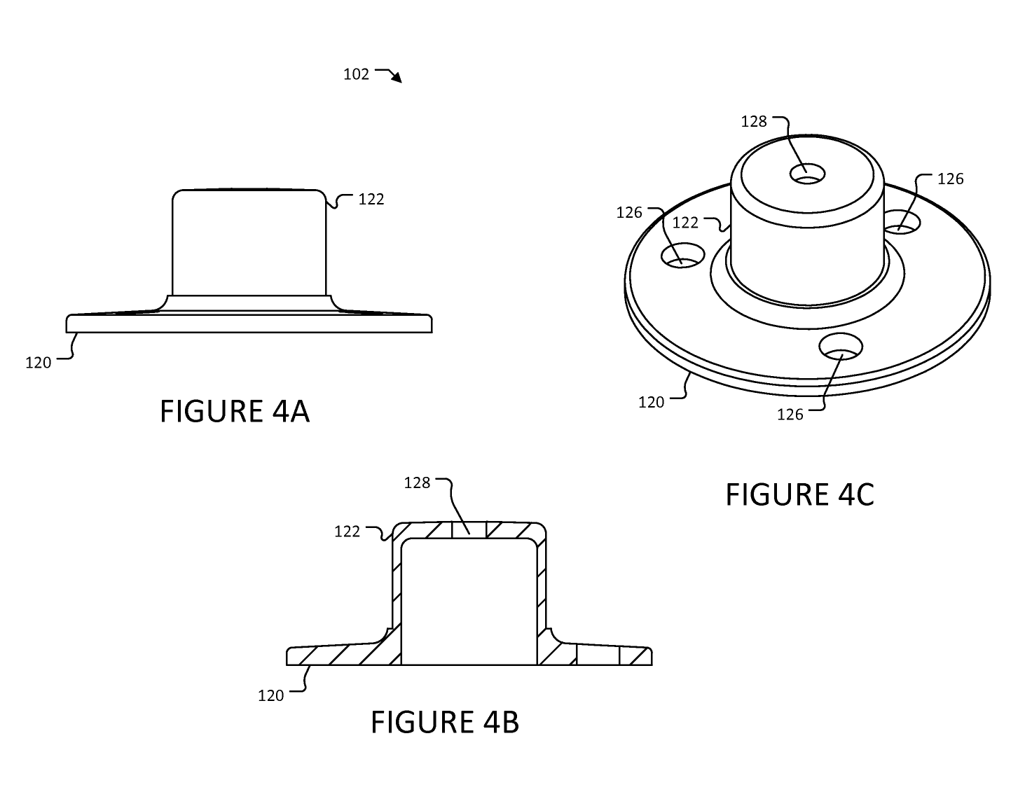

Referring to FIGS. 4A-4C, detailed diagrams of the flange 102 are illustrated. As shown in FIGS. 4A-4C, the flange 102 can generally include a base 120 and a protruding member 122. The base 122 can generally have a substantially circular shape. It is to be appreciated that the base 122 can have different shapes without exceeding a scope of the present invention. The base 122 can typically include one or more holes 126 to receive a fastener, as shown in FIG. 4C. For instance, the plurality of fasteners 114 can be implemented to secure the flange 102 via the one or more holes 126 to a structure, as shown in FIG. 2. It is to be appreciated that other means of securing the base 122 to a structure are contemplated.

As shown generally in FIGS. 4A-4C, the protruding member 122 can extend above the base 120. Generally, the protruding member 122 can be a cylinder located approximately concentric to the base 120. As shown in FIG. 4C, the protruding member 122 can typically include a hole 128 located approximate a top of the protruding member 122 and centered on the protruding member 122. The hole 128 can be sized to allow a portion of the flange bolt 104 to pass through. Typically, a head of the flange bolt 104 will not pass through the hole 128. In some embodiments, a washer can be implemented with the flange bolt 104 to keep the flange bolt 104 from passing through the hole 128. The hole 128 can be implemented to couple the flange 102 to the expansion member nut 108 via the flange bolt 104.

Generally, the protruding member 122 can have a diameter smaller than an interior diameter of the rail being coupled to the rail coupling assembly 100. For instance, the protruding member 122 can have a substantially circular cross-section with a diameter approximately smaller than the rail 150.

In one embodiment, the flange 102 can be fabricated from one or more components. For instance, a fabricated flange can include a floor flange and a tube directly coupled to the floor flange. Typically, the tube can include an open end and a closed end. The closed end can typically include an aperture approximate an upper center portion of the tube, as shown in FIG. 4C. In another embodiment, the flange 102 can be cast as one piece. The flange 102 can typically be manufactured from a rigid material including, but not limited to, aluminum, steel, and rigid polymers.

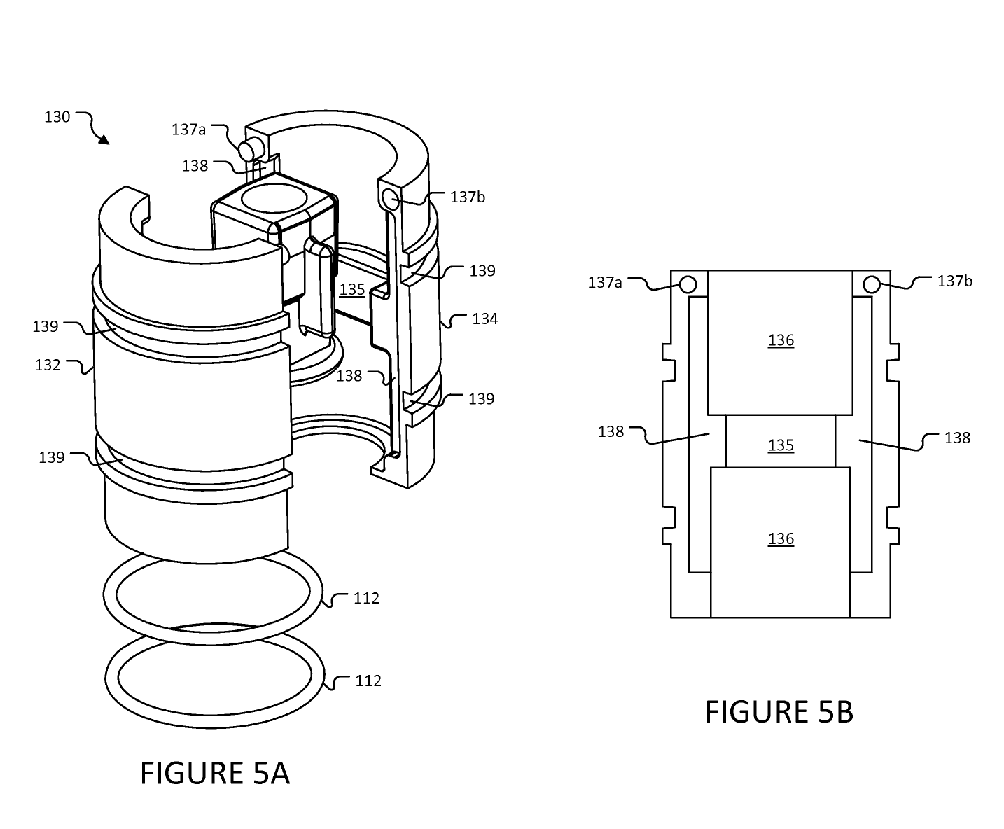

Referring to FIG. 5A-5B, detailed diagrams of one embodiment of the expansion member 106 are illustrated. Typically, the expansion member 106 can include a housing 130 adapted to encase the expansion member nut 108, as shown in FIG. 5A. In one embodiment, the housing 130 can generally have a substantially cylindrical shape with a substantially circular cross-section. It is to be appreciated that the housing 130 can include other shapes to fit inside differently shaped rails, pipes, etc. For example, the housing 130 may have a substantially rectangular shape to fit inside a rail having a rectangular shape. The expansion member 106 can be adapted to increase in diameter to interface with and couple to an interior of a rail or pipe.

In one embodiment, as shown generally in FIG. 5A, the housing 130 can include a first member 132 and a second member 134. The housing members 132, 134 can form a bore 136 when coupled together. Typically, each of the housing members 132, 134, can include a bore protrusion 135 approximate a middle interior portion of the housing members 132, 134, as shown in FIGS. 5A and 5B. The bore protrusions 135 can be implemented to interface with the expansion member nut 108.

To keep the housing members 132, 134 from rotating in relation to one another, the housing members 132, 134 can each include a protrusion 137a and a receptacle 137b. The first member receptacle 137b can be adapted to receive the second member protrusion 137a and the second member receptacle 137b can be adapted to receive the first member protrusion 137a. It is to be appreciated that other means of keeping the housing members 132, 134 from rotating in relation to one another are contemplated.

In one embodiment, the housing members 132, 134 can form a pair of slots 138 when coupled together. The slots 138 can be implemented to interface with the expansion member nut 108, as described hereinafter.

In embodiments implementing the housing members 132, 134, the expansion member 106 can include the plurality of elastic rings 112. The plurality of elastic rings 112 can be implemented to couple the housing members 132, 134 together. For instance, the elastic rings 112 can be adapted to fit into channels 139 of the housing 130. The channels 139 are generally located on an exterior of the housing 130. As shown in FIG. 5A, a first channel 139 can be located approximate a middle upper portion of the housing 130 and a second channel can be located approximate a middle lower portion of the housing 130. The elastic rings 112 can generally comprise an elastomer allowing the housing members 132, 134 to separate and expand. It is to be appreciated that other means of coupling the housing members 132, 134 together are contemplated.

Referring to FIG. 5B, a front interior view of one of the housing members 132, 134 is illustrated. As shown, the housing members 132, 134 can include the bore 136, the protrusion 135, and the pair of slots 138. Typically, the housing members 132, 134 can be identical housing members.

The expansion member 106 can be implemented to couple to an interior of a rail or pipe. For instance, the expansion member 106 can be inserted into the rail 150 and then expanded to interface with and couple to the rail 150. Generally, the expansion member 106 can comprise a rigid material. For instance, the expansion member 106 can be manufactured from rigid materials including, but not limited to, steel, aluminum, and rigid polymers. In one embodiment, the expansion member 106 can be comprised of a steel alloy being resistant to rusting. It is to be appreciated that the expansion member 106 can be fabricated or cast when manufactured from a metal.

Generally, the expansion member 106 can be operatively coupled to the flange 102 by the flange bolt 104. In operation, as the flange bolt 104 is threaded through the expansion member nut 108, the housing members 132, 134 of the expansion member 106 can be expanded against an interior surface of a pole or a rail, as shown in FIGS. 3A-3C. As the flange bolt 104 is threaded further, the expansion member 106 can be pulled towards the flange 102.

Once the rail contacts the flange 102, and the flange bolt 104 is threaded even further, a load bearing connection can be created between an end of the rail and the flange 102. Typically, the end of the rail can be brought into contact with the flange 102 as the flange bolt 104 is tightened. In some embodiments, a very solid joint between the flange 102 and the rail can be created. For instance, the rail coupling assembly 100 can be implemented in place of welding a rail to a flange.

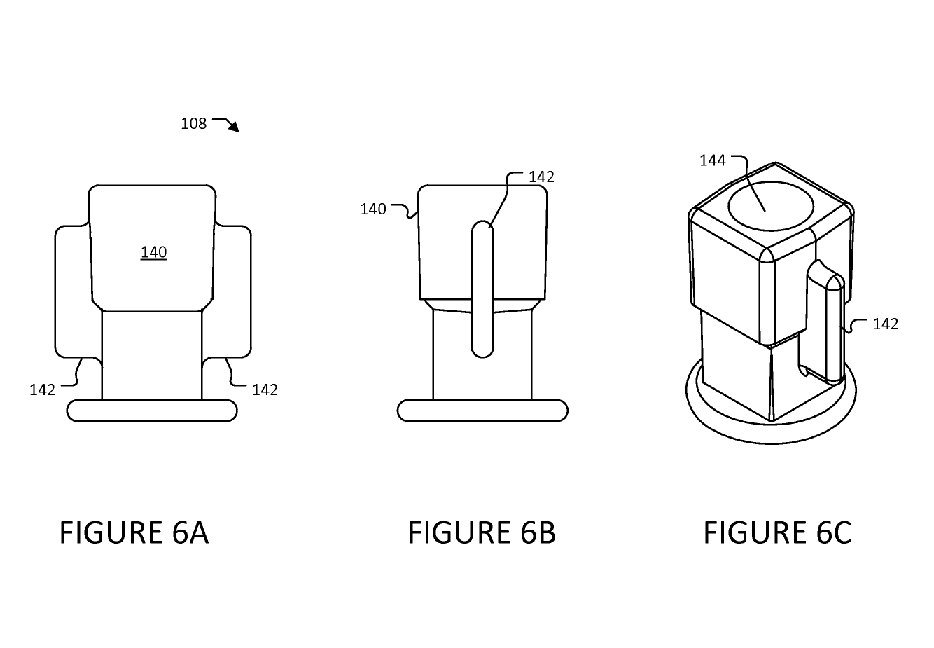

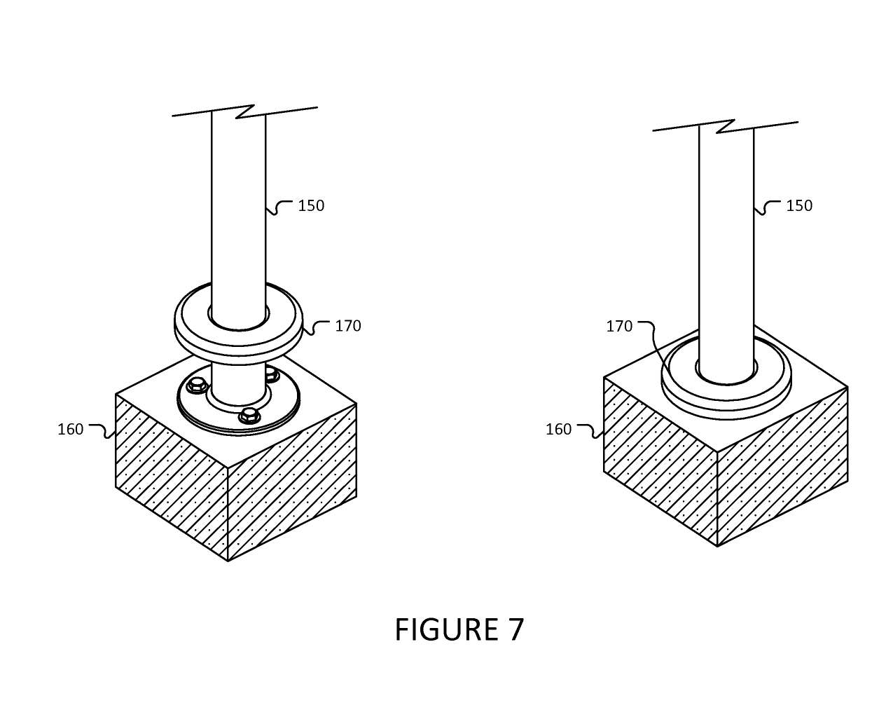

Referring to FIGS. 6A-6C, detailed diagrams of one embodiment of the expansion member nut 108 are illustrated. The expansion member nut 108 can generally include a housing 140, a pair of juts 142, and a bore 144. The bore 144 of the expansion member nut 108 can be adapted to receive the flange bolt 104. Generally, as the flange bolt 104 is threaded through the bore 144, the expansion member nut 108 can be adapted to expand the housing members 132, 134 apart. For instance, the expansion member nut 108 can be implemented to increase a diameter of the expansion member 106 as the flange bolt 104 is threaded through the bore 144.

The nut housing 140 can generally have a tapered shape where the nut housing 140 has a greater width approximate an upper portion of the nut housing 140. For instance, the nut housing 140 can generally taper down towards a lower portion of the nut housing 140, as shown in FIG. 6B. The bore 144 can typically be threaded to receive and couple to a threaded fastener. For instance, the bore 144 can be threaded to couple to the flange bolt 104. The juts 142 can typically be slidably engaged to the slots 138 of the expansion member 106. Generally, the juts 142 can be implemented to keep the nut housing 140 from rotating inside the bore 136 of the expansion member 106. For instance, as the flange bolt 104 is threaded through the nut bore 144, the juts 142 can keep the nut housing 140 from rotating with the flange bolt 104.

In a typical implementation, the flange bolt 104 can be threadably coupled to the bore 144 of the tapered nut 108. As the flange bolt 104 is threaded through the bore 144, a distance between the tapered nut 108 and the flange 102 can be shortened. As the tapered nut 108 moves through the bore 136 of the expansion member 106, the tapered nut 108 can interface with the protrusions 135 of the expansion member 106. The wider portion of the tapered nut 108 can push against the protrusions 135, thus separating the housing members 132, 134. The expansion member 106 can be expanded outwardly, with the housing members 132, 134 moving apart and interfacing with and coupling to an interior of a rail.

In another embodiment, the juts 142 can be adapted to move in and out of the nut housing 140. The juts 142 can be adapted to interface with the flange bolt 104 inside the nut bore 144. In such an embodiment, the juts 142 can each include an edge being tapered. The tapered edge can generally be located inside the nut bore 144. As the flange bolt 104 is threaded through the bore 144, the juts 142 can be moved outwardly. For instance, the juts 142 can be pushed away from the expansion member nut housing 140 as the flange bolt 104 moves through the bore 144. As the juts 142 expand outwardly, the housing members 132, 134 can be pushed apart.

Referring back to FIGS. 3A-3C, the plurality of washers 110 can be implemented between the flange 102 and the expansion member 106. As the flange bolt 104 is threaded through the tapered nut 108, the washers 110 can act like a coil spring by providing a restorative force to the flange 102 and the expansion member 106. The washers 110 can be implemented to allow the support rail 150 to nest with a large force against the base 120 of the flange 102.

In one embodiment, the washers 110 can be comprised of rubber. It is to be appreciated that other structures similar to washers are contemplated. For instance, a semi-rigid cylindrical member can be implemented in place of the washers 110. In one example, the semi-rigid cylindrical member can be comprised of closed-cell foam. It is to be appreciated that numerous materials may be used to form the semi-rigid member as would be obvious to one of ordinary skill in the art given the benefit of this disclosure.

The washers 110 can generally have two functions in the rail coupling assembly 100. First, the washers 110 can be implemented to maintain a gap between the expansion member 106 and the flange 102. As the flange bolt 104 is threaded through the expansion member nut 108, the washers 110 can prevent the expansion member 106 from moving towards the flange 102. Continued threading of the flange bolt 104 through the expansion member nut 108 causes the expansion member 106 to expand, as previously described, and thereby creating a large friction force between the expansion member 106 and the rail 150. The friction force can keep the expansion member 106 and the rail 150 coupled together. Secondly, the washers 110 can act as a cushion between the flange 104 and the expansion member 106 plus the rail 150. As the flange bolt 104 is threaded further through the expansion member nut 108, the rail 150 can be pressed against the base 120 of the flange 104. As the rail 150 is pressed against the flange 104, the washers 110 can compress and provide a restorative force to the expansion member 106 and the protruding member 122 of the flange 102.

Referring to FIG. 7, a detailed diagram of the rail coupling assembly 100 including an escutcheon plate 170 is illustrated. In some embodiments, the rail coupling assembly 100 can include the escutcheon plate 170 to provide aesthetic value to the rail coupling assembly 100. As shown, the escutcheon plate 170 can be sized to cover the base 120 of the flange 102. Typically, the escutcheon plate 170 can include a hole through which the rail 150 can fit through. The escutcheon plate 170 can generally be implemented to cover up the use of the rail coupling assembly 100, such that the rail 150 appears to be directly coupled to the pool deck 160. For instance, when installed, the rail coupling assembly 100 should not be visible. The installed rail 150 can then appear to look as if the rail 150 was an integral part of the pool deck 160. It is to be appreciated that over decorative coverings are contemplated in lieu of using an escutcheon plate.

### An Embodiment of a Rail Coupling System

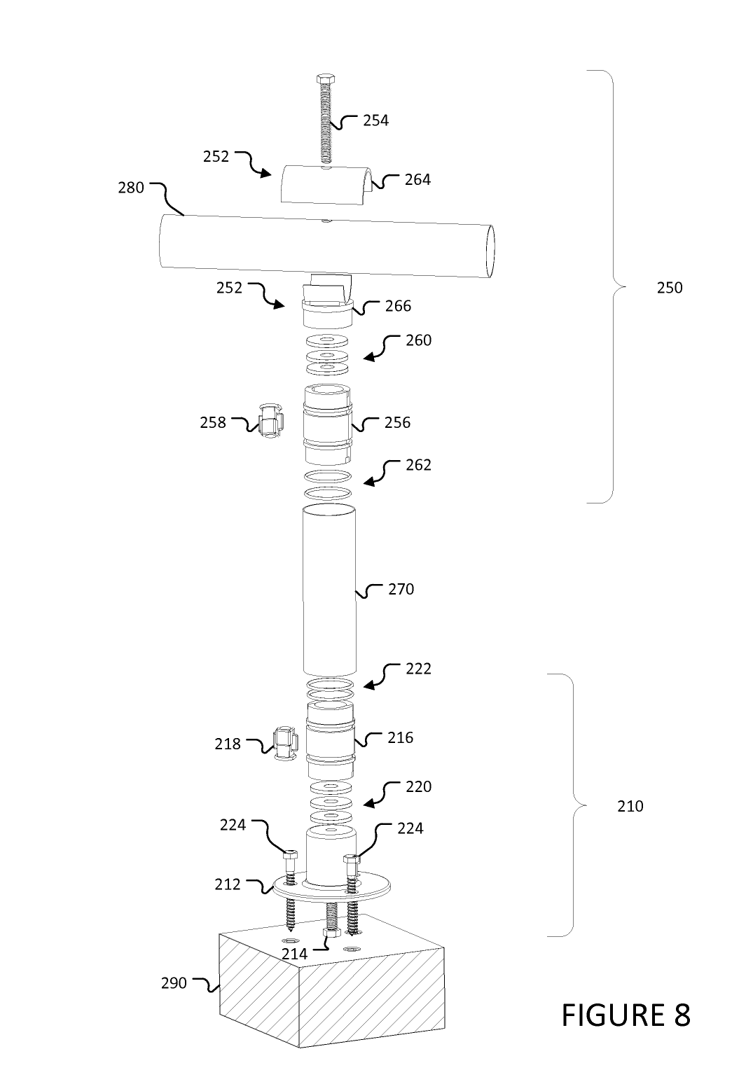

Referring to FIG. 8, an exploded view of an embodiment 200 showing a rail coupling system is illustrated. Generally, the rail coupling system 200 can include a first rail coupling assembly 210 and a second rail coupling assembly 250. The rail coupling system 200 can be implemented to couple a pair of rails together and to a structure. For instance, a first rail 270 can couple to a structure 290 and a second rail 280 can be a hand rail coupled to the first rail 270.

As shown in FIG. 8, the first rail coupling assembly 210 can be substantially similar to the first embodiment rail coupling assembly 100. The first rail coupling assembly 210 can include a flange 212, a flange bolt 214, an expansion member 216, an expansion member nut 218, a plurality of washers 220, a plurality of elastic rings 222, and one or more fasteners 224. The first rail coupling assembly 210 can be implemented to couple a rail to a structure. For instance, the first rail coupling assembly 210 can be implemented to couple the first rail 270 to the structure 290. In one example, first rail 270 can be a support rail for a hand rail coupled to a pool deck.

The second rail coupling assembly 250 can include components similar to the first rail coupling assembly 210. The second rail coupling assembly 250 can typically include an attachment structure 252, an attachment structure bolt 254, an expansion member 256, an expansion member nut 258, a plurality of washers 260, and a plurality of elastic rings 262. The second rail coupling assembly 250 can typically be implemented to couple a pair of rails together. For instance, the second rail coupling assembly 250 can be implemented to couple the first rail 270 to the second rail 280.

In one embodiment, the attachment structure 252 can include a first member 264 and a second member 266. As shown, the first member 264 can be an elongated semi-spherical plate adapted to form to the second rail 280. The first member 264 can include a hole through which the attachment structure bolt 254 can pass through. The second member 266 can include a shortened semi-spherical plate including a protruding member similar to the protruding member 122 of the first embodiment flange 104. The second member 266 can include a hole through which the attachment structure bolt 254 may pass through.

The first rail coupling assembly 210 and the second rail coupling assembly 250 can each be implemented similarly to the first embodiment rail coupling assembly 100. The expansion members 216, 256 can be inserted into, and coupled to, the first rail 270. The attachment structure 252 can be implemented to couple the second rail 280 to the first rail 290 at approximately a 90 degree angle in relation to one another. The flange bolt 214 and the attachment structure bolt 254 can be implemented to threadably couple to a respective expansion member nut 218, 258. As the bolts 214, 254 are threaded through the expansion member nuts 218, 258, the expansion members 216, 256 can expand to interface with and couple to an interior of the first rail 270. As the bolts 214, 254 are threaded more, the expansion members 216, 256 can be pulled towards the flange 212 and the attachment structure 252, respectively. The coupling assemblies 210, 250 can create a near weld-like connection between the first rail 270 and the flange 212 and the first rail 270 and the attachment structure 252. A load bearing connection can be created between the first coupling assembly 210 and the first rail 270.

As shown in FIG. 8, the attachment structure 252 can be implemented to secure the second rail 280 to the first rail 270. Generally, the second rail 280 can be oriented substantially perpendicular to the first rail 270 when coupled together. It is to be appreciated that the attachment structure 252 can be adapted to couple the second rail 280 to the first rail 270 at an angle between 15 to 90 degrees. For instance, the rail coupling system 200 can be implemented to couple support rails to a hand rail on a set of stairs and the support rails to steps of the set of stairs. In such an embodiment, the hand rail can be coupled to the support rails at an angle of 45 degrees.

### A Second Embodiment of a Rail Coupling Assembly

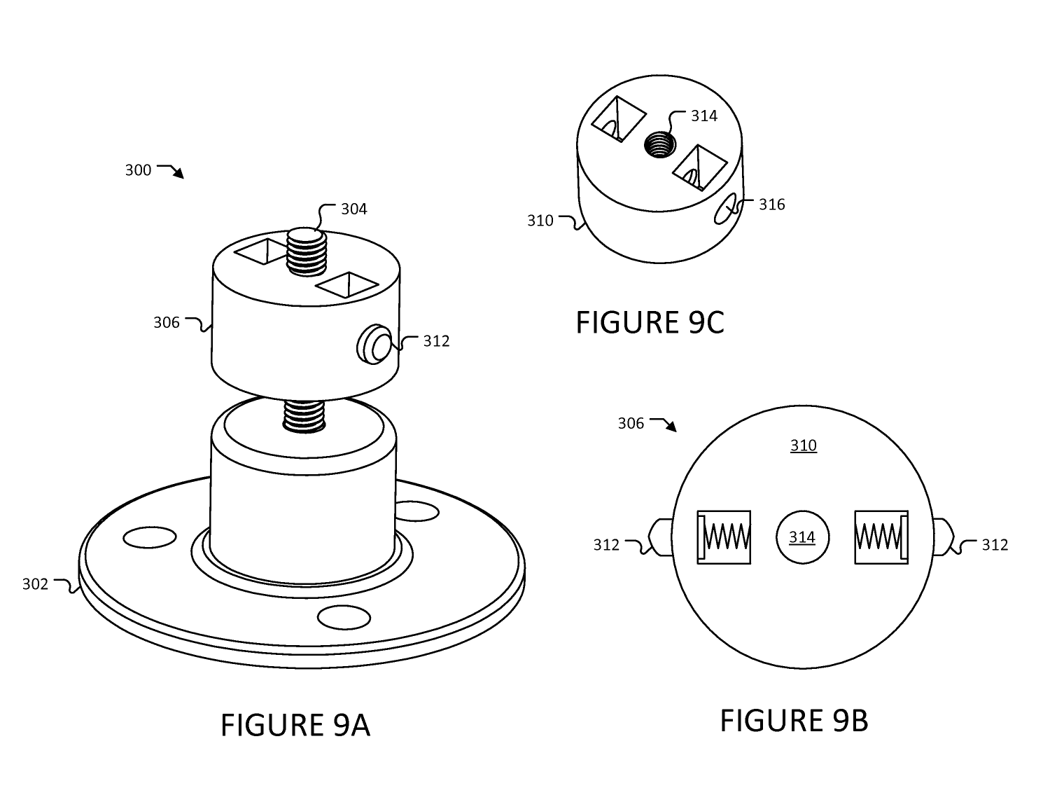

Referring to FIGS. 9A-9C, detailed diagrams of a second embodiment 300 of a rail coupling assembly is illustrated. Typically, the second embodiment rail coupling assembly 300 can be implemented similarly to the first embodiment rail coupling assembly 100 to couple to a rail.

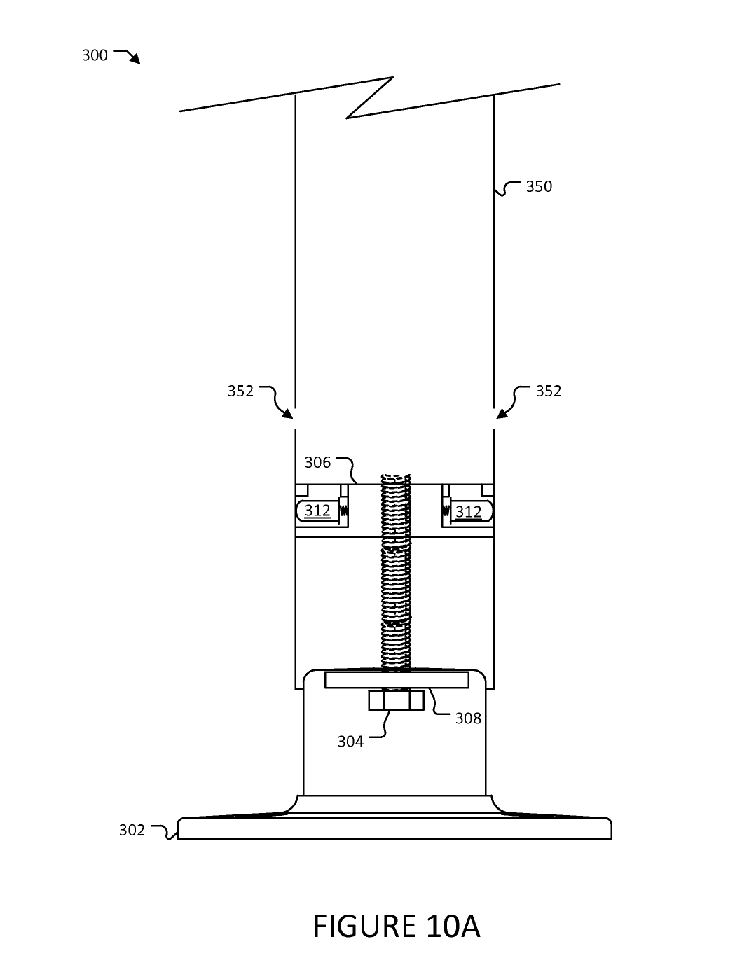

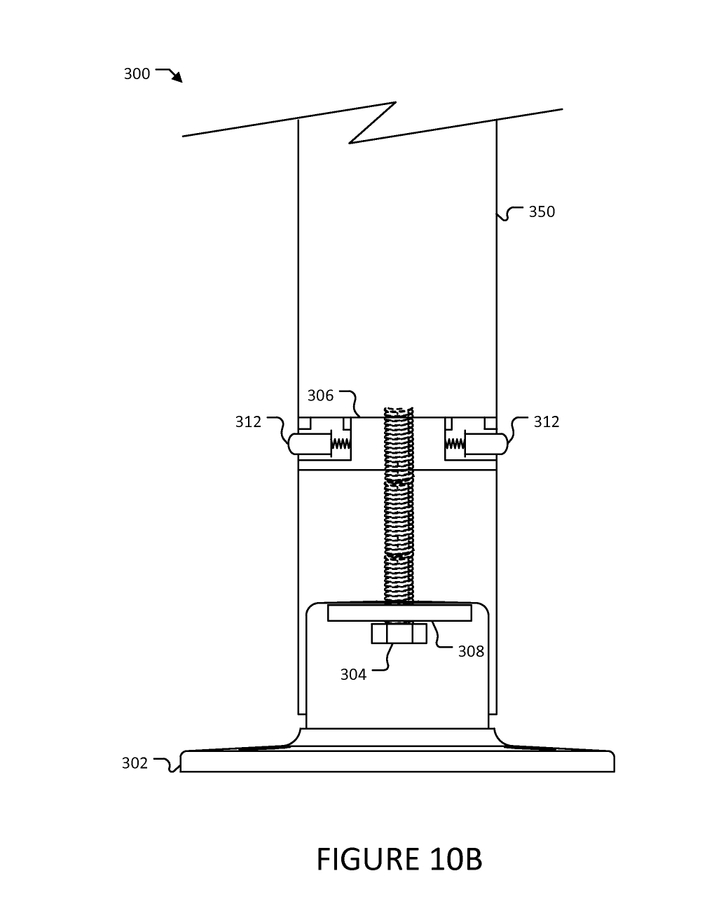

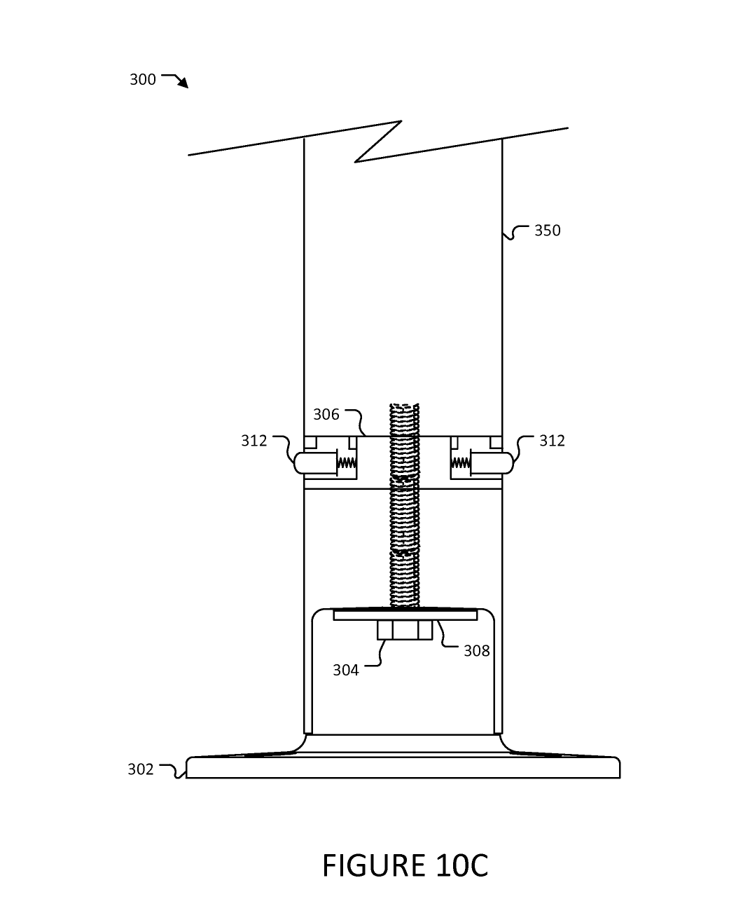

As shown in FIGS. 9A-9C, the second embodiment rail coupling assembly 300 can generally include a flange 302, a flange bolt 304, a rail engagement member 306, and a semi-rigid member 308 (shown in FIGS. 10A-10C). The flange 302, the flange bolt 304, and the semi-rigid member 308 can be substantially similar to the first embodiment components. For instance, the flange 302 can include a base and a protruding member. The protruding member can include a hole for the flange bolt 304 to pass through. The semi-rigid member 308 can be similar to the first embodiment washers 110. For instance, the semi-rigid member 308 can provide a restorative force to the flange bolt 304 to create a tighter fit between a rail and the flange 302. In one embodiment, the semi-rigid member 308 can be replaced with a rigid washer.

As shown in FIG. 9B, the rail engagement member 306 can include a housing 310, a pair of spring-loaded protruding members 312, and a threaded bore 314. The housing 310 can generally be manufactured from a rigid material. In one embodiment, the housing 310 can be cast. In another embodiment the housing 310 can be machined from a solid block of material. As shown, the rail engagement member 306 can have a diameter substantially similar to the diameter of the protruding member of the flange 302. It is to be appreciated that the flange 302 and the rail engagement member 306 can be sized to fit inside a particular rail.

Typically, the pair of spring-loaded protruding members 312 can be located on opposite sides of the housing 310. The pair of spring-loaded protruding members 312 can be adapted to extend out from sides of the housing 310 to engage holes in a rail. Generally, the pair of spring-loaded protruding members 312 can be biased to extend out of the sides of the housing 310.

As shown in FIGS. 9A and 9C, the housing 310 can generally have a substantially cylindrical shape with a pair of apertures 316 located on sides of the housing 310. The pair of spring loaded protruding members 312 can be adapted to slide in and out of the housing apertures 316. The threaded bore 314 can be adapted to receive and threadably couple to the flange bolt 304.

Referring to FIGS. 10A-10C, a typical implementation of the second embodiment rail coupling assembly 300 being coupled to a support rail 350 is illustrated. In an initial step (not shown), the second embodiment rail coupling assembly 300 can be partially inserted into the support rail 350. Typically, a portion of the flange 302, the flange bolt 304, the semi-rigid member 308, and the rail engagement member 306 can be inserted into the support rail 350. The rail 350 can typically include a pair of apertures 352 adapted to receive the pair of spring-loaded protruding members 312.

As shown in FIG. 10A, the rail engagement member 306 can generally fit inside the support rail 350 such that the housing 310 and the pair of spring-loaded protruding members 312 of the rail engagement member 306 can be moved through the support rail 350. As shown, the spring-loaded protruding members 312 can be pushed inside the housing apertures 316. The flange bolt 304 can be passed through the flange 302 and the semi-rigid member 308 and threadably coupled to the bore 314 of the rail engagement member 306.

As shown in FIG. 10B, the rail 350 can be passed over the rail engagement member 306 until the pair of spring-loaded protruding members 312 meet the pair of holes 352 in the rail. The pair of holes 352 in the rail 350 can be sized to allow the spring-loaded protruding members 312 to pass through. The rail engagement member 306 can detachably couple to the rail 350 when the spring-loaded protruding members 312 expand out through the pair of holes 352 of the rail. As the flange bolt 304 is threaded further through the bore 314, the rail engagement member 306 coupled to the rail 350 can be drawn closer to the flange 302.

As shown in FIG. 10C, the flange 302 and a bottom portion of the rail 350 can be connected together. As the flange bolt 304 is threaded even further through the bore 314 of the rail engagement member 306, the rail 350 can be pulled closer to the flange 302. As the rail engagement member 306 is pulled closer to the flange 302, the rail 350 can be pulled down to interface with the flange 302. A load bearing connection between the rail 350 and the flange 302 can be created by further threading the flange bolt 304 through the bore 314 of the rail engagement member 306.

Typically, the semi-rigid member 308 can be implemented to provide a restorative force to the flange bolt 304 as the flange bolt 304 is pulled tighter to the flange 302. As shown in FIG. 10C, the semi-rigid member 308 can be compressed as the flange bolt 304 is pulled tighter to the flange 302. The restorative force from the semi-rigid member 308 can create a tighter fit between the flange 302 and the rail 350. For instance, a connection having substantially weld-like strength can be created between the flange 302 and the bottom portion of the rail 350.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A rail coupling assembly comprising:
a flange having a base and a protruding member, wherein the protruding member includes a hole;
an expansion member adapted to increase in diameter;
a nut located within the expansion member;
a semi-rigid member located between the expansion member and the protruding member of the flange; and
a bolt passed through the hole of the protruding member and threadably coupled to the nut.

2. The rail coupling assembly of claim 1, wherein the expansion member includes a bore having a protrusion and a pair of slots.

3. The rail coupling assembly of claim 2, wherein the nut has a tapered shape and includes a pair of juts adapted to interface with the pair of slots of the expansion member.

4. The rail coupling assembly of claim 2, wherein the nut is located within the bore of the expansion member.

5. The rail coupling assembly of claim 4, wherein the nut is adapted to interface with the protrusion of the expansion member.

6. The rail coupling assembly of claim 5, wherein the expansion member increases in diameter as the nut interfaces with the protrusion.

7. The rail coupling assembly of claim 1, wherein the nut includes a threaded bore for receiving the bolt.

8. The rail coupling assembly of claim 1, wherein the rail coupling assembly is adapted to couple to a rail.

9. The rail coupling assembly of claim 8, wherein a load bearing connection between the flange and the rail is created when the rail coupling assembly is coupled to the rail.

10. The rail coupling assembly of claim 1, wherein the assembly further includes an escutcheon plate.

11. A rail coupling assembly kit comprising:
a flange adapted to be coupled to a structure;
an expansion member adapted to insert into and couple to a rail, the expansion member adapted to be operatively coupled to the flange;
a nut adapted to interface with an interior of the expansion member;
a semi-rigid member adapted to be located between the expansion member and the flange;
a bolt adapted to (i) threadably couple to the nut and (ii) operatively couple the flange, the semi-rigid member, and the expansion member together; and
one or more fasteners adapted to couple the flange to the structure.

12. The rail coupling assembly kit of claim 11, wherein the flange includes a base and a protruding member.

13. The rail coupling assembly kit of claim 11, wherein the structure is a concrete structure.

14. The rail coupling assembly kit of claim 11, wherein the expansion member is adapted to increase in diameter.

15. The rail coupling assembly kit of claim 11, wherein the semi-rigid member includes a plurality of rubber washers.

16. The rail coupling assembly kit of claim 11, wherein the expansion member is manufactured from a metal.

17. The rail coupling assembly kit of claim 11, wherein the kit is adapted to create a load bearing connection between the rail and the flange.

18. The rail coupling assembly kit of claim 11, wherein the kit is adapted to first be coupled to the rail and then coupled to the structure.

19. The rail coupling assembly kit of claim 11, wherein the kit further includes an escutcheon plate.

20. A rail coupling assembly comprising:
a flange including:
a base having one or more holes adapted to receive a fastener; and
a protruding member including a hole;
an expansion member including:
a housing having a bore;
a pair of slots; and
a protrusion located on an interior of the housing;
a tapered nut having a pair of juts and a threaded bore, wherein (i) the tapered nut is located within the bore of the expansion member, (ii) the tapered nut is adapted to interface with the protrusion of the expansion member, and (iii) the pair of juts are adapted to fit into the pair of slots of the expansion member;
a plurality of washers located between the expansion member and the flange; and
a bolt passed through the hole of the protruding member, the plurality of washers, and the bore of the expansion member, wherein the bolt is threadably coupled to the threaded bore of the tapered nut.
